(19) United States
(12) Patent Application Publication
(10) Pub. No.: US 2012/0315577 A1
(43) Pub. Date: Dec. 13, 2012

(54) Liquid Developer

(75) Inventors: Miyuki MORIGUCHI, Kobe-shi (JP); Masahiro ANNO, Osaka (JP); Naoki YOSHIE, Osaka (JP); Chiaki YAMADA, Osaka (JP); Keiko MOMOTANI, Osaka (JP); Kenji HAYASHI, Tokyo (JP); Yuya KUBO, Tokyo (JP)

(73) Assignee: KONICA MINOLTA HOLDINGS, INC., Tokyo (JP)

(21) Appl. No.: 13/488,994

(22) Filed: Jun. 5, 2012

(30) Foreign Application Priority Data
Jun. 13, 2011 (JP) 2011-131160

(51) Int. Cl. G03G 9/13

(52) U.S. Cl. 430/114

(57) ABSTRACT

A liquid developer includes toner particles, an insulating liquid, and a dispersant, and is characterized in that the toner particles includes a resin and a pigment dispersed in the resin, the resin includes a polyester resin, the dispersant includes a basic polymeric dispersant, and a solid obtained by drying the liquid developer has a melting point of at least 55° C.

This application is based on Japanese Patent Application No. 2011-131160 filed with the Japan Patent Office on Jun. 13, 2011, the entire content of which is hereby incorporated by reference.

### BACKGROUND OF THE INVENTION

1. Field of the Invention

The present invention relates to a liquid developer used for an electrophotographic image forming apparatus.

2. Description of the Related Art

As a developer used for an electrophotographic image forming apparatus, a developer in the form of powder has conventionally been used. In such a powder developer (so-called toner), a pigment is dispersed in a resin. The powder toner, however, has a problem that if the size of particles is made smaller, the dispersion property is deteriorated, which makes it difficult to uniformly charge the developer. It has therefore been necessary to set the lower limit of the particle size to 5 to 6 μm or more. An image formed by this apparatus, however, has a higher quality as the particle size is smaller, and thus there has been a demand for a further reduction of the particle size.

Accordingly, a liquid developer is of interest for which the dispersion property can be controlled in an insulating liquid and the size of toner particles can further be reduced (Japanese Laid-Open Patent Publication Nos. 2009-175670, 2005-062466, 2004-287314, and 03-266854).

### SUMMARY OF THE INVENTION

Toner particles included in such a liquid developer are usually made up of a resin and a pigment. As to the resin included in the toner particles, a resin having a higher glass transition point (Tg) or melting point (hereinafter simply referred to as “glass transition point”) is considered preferable in terms of the strength of fixing when the liquid developer is fixed on a recording material and in terms of thermostable storage of the liquid developer. In general, a resin having a glass transition point of 55° C. or more is used.

However, even if toner particles include such a resin having a high glass transition point, the glass transition point of the resin tends to decrease after these toner particles are dispersed in an insulating liquid. Namely, when the glass transition point of a solid into which the liquid developer is dried is measured, the measured glass transition point is lower than the inherent glass transition point of the resin which is a component of the toner particles. A reason for this may be that the insulating liquid remains on the surface of toner particles and in the resin and plasticizes the resin.

A resultant problem has therefore been as follows. If such a liquid developer is used to form images on recording materials and respective image faces are overlapped to abut on each other, the image faces stick to each other even after undergoing thermal fixing, namely document offset occurs.

The present invention has been made in view of the circumstances above, and an object of the present invention is to provide a liquid developer that can reduce occurrence of the document offset.

The inventors of the present invention have conducted thorough studies for solving the problems above and accordingly obtained the following finding. Namely, a mere increase of the glass transition point of the resin used for the toner particles cannot solve the problems, and the most effective way to solve the problems is to reduce incorporation of the insulating liquid into the resin. Based on this finding, studies have further been conducted and finally the present invention has been reached.

Specifically, a liquid developer of the present invention includes toner particles, an insulating liquid, and a dispersant, and is characterized in that the toner particles include a resin and a pigment dispersed in the resin, the resin includes a polyester resin, the dispersant includes a basic polymeric dispersant, and a melting point of a solid obtained by drying the liquid developer is at least 55° C.

Here, preferably the polyester resin includes units derived from an acid component and units derived from an alcohol component, and a total amount of units derived from an aliphatic monomer included in the units derived from an acid component and the units derived from an alcohol component is 30 to 80 mol %. Preferably the basic polymeric dispersant includes, in its molecules, any one of a urethane group, an amide group, and a pyrrolidone group.

The liquid developer of the present invention has the above-described characteristics to thereby provide an excellent effect that occurrence of the document offset is reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a graph showing a result of measurement of a shoulder value of an endothermic shift.

FIG. 2 is a schematic conceptual diagram of an electrophotographic image forming apparatus.

### DESCRIPTION OF THE PREFERRED EMBODIMENTS

In the following, the present invention will be described in further detail.

<Liquid Developer>

The liquid developer of the present invention includes toner particles, an insulating liquid, and a dispersant. As long as the liquid developer includes these components, it may include other arbitrary components. These other components may include, for example, charge control agent, thickener, and the like. Here, the ratio of the content of each component may be, for example, 8 to 50 mass % of the toner particles, 50 to 90 mass % of the insulating liquid, and 0.1 to 10 mass % of the dispersant relative to the mass of the toner particles. Such a liquid developer is useful as a developer for an electrophotographic image forming apparatus.

The liquid developer of the present invention is characterized in that a solid obtained by drying the liquid developer has a melting point of 55° C. or more. Accordingly, the liquid developer of the present invention provides an excellent effect that occurrence of the document offset is reduced. Such an effect cannot be obtained by merely increasing the glass transition point of the resin which is a component of the toner particles, but be obtained only by setting the melting point to 55° C. or more of the solid into which the liquid developer has been dried. The reason for this is supposed to be as follows. In the case where the melting point of a solid into which a liquid developer has been dried is set to 55° C. or more, the insulating liquid, which is a component of the liquid developer, after being fixed on a recording material is prevented from remaining in toner particles or around toner particles, and accordingly occurrence of the document offset, which is considered as occurring due to such a remaining insulating liquid, is reduced.

In view of the above, a higher melting point of the solid into which the liquid developer has been dried is preferred, and therefore, it is not particularly necessary to limit the upper limit of the melting point. However, in view of the fact that a higher melting point results in a higher temperature of crystallization in a granulation process and resultant deterioration of the granulation property, the upper limit is preferably 70° C. or less. For the present invention, the above-described melting point can be measured in the way described below.

The composition of the liquid developer of the present invention exhibiting these characteristics will hereinafter be described.

<Toner Particles>

The toner particles included in the liquid developer of the present invention include a resin and a pigment dispersed in the resin. As long as the toner particles include these components, other arbitrary components may also be included. These other components may include, for example, wax, dispersant (pigment dispersant), charge control agent, and the like.

Here, the ratio between respective contents of the resin and the pigment may be determined so that the concentration of the pigment exhibited when one toner-particle layer having a thickness corresponding to a single toner particle is formed has a desired concentration. For example, the ratio of the content of the resin may be 70 to 99 mass %, and may more preferably be 75 to 95 mass %. In the case where the ratio of the content of the resin is less than 70 mass %, the binding force between the toner particles is lessened and the strength of fixing to a recording material tends to deteriorate. In the case where the ratio of the content of the resin exceeds 99 mass % (namely the ratio of the content of the pigment is less than 1 mass %), the concentration of the pigment that can be achieved by a single thin layer of the toner particles is low, which may make it difficult to create a desired color.

The particle size of such toner particles is not particularly limited. In order to obtain a high-quality image, the particle size is preferably 0.1 to 3.5 μm, and is more preferably 0.5 to 2.5 μm. These particle sizes are smaller than the particle size of toner particles of the powder developer (dry developer) which has conventionally been used, and therefore provide one characteristic of the present invention.

It is noted that “particle size” used for the present invention means an average particle size, and can be identified as a volume average particle size by means of various particle size distribution meters.

<Resin>

The resin included in the toner particles of the present invention is required to include a polyester resin having a high resin strength obtained by hydrogen bonding between or within resin molecules and having an excellent offset resistance. Preferably, the content of such a polyester resin is at least 90 mass % relative to the whole resin. More preferably, the resin is constituted of such a polyester resin only except for inevitable impurities. In the following, such a polyester resin will be described.

<Polyester Resin>

The above-described polyester resin is characterized in that the polyester resin includes units derived from an acid component (hereinafter also referred to as “acid component units”) and units derived from an alcohol component (hereinafter also referred to as “alcohol component units”), and that the total amount of units derived from an aliphatic monomer that are included in the acid component units and the alcohol component units is 30 to 80 mol % (not less than 30 mol % and not more than 80 mol %). A single polyester resin as described above may solely be used or a combination of two or more different polyester resins may be used.

When the total amount of units derived from an aliphatic monomer included in the acid component units and the alcohol component units is 30 mol % or more, the molecular chains of the polyester resin are regularly arranged (i.e., the crystallinity of the polyester resin is improved), and therefore the insulating liquid can effectively be prevented from entering the resin and therefore plasticization due to the insulating liquid can effectively be avoided. Thus, the solid obtained by drying the liquid developer can have a melting point of 55° C. or more and the document offset can be prevented. Further, when the amount of the units derived from an aliphatic monomer included in the acid component units and the alcohol component units exceeds 80 mol %, the solubility of the polyester resin in an organic solvent is deteriorated and accordingly, deterioration of the granulation property such as generation of large particles in the process of producing toner particles occurs.

The polyester resin of the present invention is basically synthesized by a polycondensation reaction between polycarboxylic acid (acid component) and polyalcohol (alcohol component). Therefore, a portion derived from the polycarboxylic acid forms the acid component units, a portion derived from the polyalcohol forms the alcohol component units, and these units are repeated to thereby constitute the polyester resin. Thus, the aliphatic monomer to form an acid component unit may be aliphatic polycarboxylic acid, lower alkyl ester thereof, acid anhydride thereof, or the like, and the aliphatic monomer to form an alcohol component unit may be aliphatic polyalcohol. Further, the total amount of units derived from an aliphatic monomer means the total amount of the units derived from an aliphatic monomer as described above included in the acid component units and the alcohol component units.

Here, the aliphatic monomer forming acid component units may, for example, be oxalic acid, malonic acid, succinic acid, glutaric acid, adipic acid, pimelic acid, suberic acid, azelaic acid, sebacic acid, 1,9-nonane dicarboxylic acid, 1,10-decane dicarboxylic acid, 1,11-undecane dicarboxylic acid, 1,12-dodecane dicarboxylic acid, 1,13-tridecane dicarboxylic acid, 1,14-tetradecane dicarboxylic acid, 1,16-hexadecane dicarboxylic acid, 1,18-octadecane dicarboxylic acid, lower alkyl ester thereof, acid anhydride thereof, or the like. Of these compounds, in terms of improvement of crystallinity of the polyester resin, adipic acid, sebacic acid, 1,10-decane dicarboxylic acid, and 1,12-dodecane dicarboxylic acid are preferably used. As such an aliphatic monomer, one of or a combination of two or more of the above-listed compounds may be used.

Further, the aliphatic monomer forming alcohol component units may, for example, be ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosanediol, or the like. Of these compounds, in terms of improvement of crystallinity of the polyester resin, ethylene glycol, 1,4-butanediol, 1,6-hexanediol, 1,9-nonanediol, 1,10-decanediol are preferably used. As such an aliphatic monomer, one of or a combination of two or more of the above-listed compounds may be used.

Each of the acid component units and the alcohol component units may include, in addition to the units derived from an aliphatic monomer, units derived from an aromatic monomer, for example. Such an aromatic monomer to form an acid component unit may be aromatic polycarboxylic acid, lower alkyl ester thereof, acid anhydride thereof, or the like, and such an aromatic monomer to form an alcohol component unit may be aromatic polyalcohol.

The aromatic monomer forming acid component units may, for example, be terephthalic acid, isophthalic acid, orthophthalic acid, t-butyl isophthalic acid, 2,6-naphthalene dicarboxylic acid, 4,4′-biphenyl dicarboxylic acid, trimellitic acid, or the like. Of these compounds, in terms of availability, terephthalic acid, isophthalic acid, and t-butyl isophthalic acid are preferably used.

Further, the aromatic monomer forming alcohol component units may, for example, be aromatic polyalcohol, specifically an alkylene oxide adduct of bisphenol A expressed by the following formula (I).

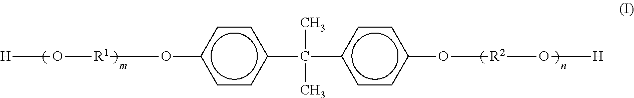

In formula (I), R¹ and R² each independently represent an alkylene group with a carbon number of 2 or 3, m and n each independently represent zero or a positive integer, and the sum of m and n is 1 to 16.

The polyester resin of the present invention may be synthesized by copolymerization of an aliphatic monomer and an aromatic monomer, or may be prepared by mixture of an aliphatic polyester obtained by copolymerization of aliphatic monomers only and an aromatic polyester obtained by copolymerization of aromatic monomers only, where they are mixed when the toner particles are produced. In the case where the aliphatic polyester and the aromatic polyester are mixed and in the case where two or more different types of polyester resins are used, the ratio of the content (mol %) of the units derived from an aliphatic monomer as described above herein refers to the ratio of the content thereof relative to the whole polyester resins (mixture).

Such a polyester resin preferably has a number-average molecular weight (Mn) of not less than 1000 and not more than 5000 and preferably has a weight-average molecular weight (Mw) of not less than 2000 and not more than 200000. It is noted that the number-average molecular weight and the weight-average molecular weight can be measured by means of GPC (Gel Permeation Chromatography).

It is noted that the ratio of the content of the units of each component in the polyester resin (including the total amount of units derived from an aliphatic monomer) can be determined by using a Fourier transform nuclear magnetic resonance apparatus (FT-NMR) (trademark: “Lambda 400” manufactured by JEOL Ltd.) and conducting ¹H-NMR analysis to obtain the integration ratio from which the ratio of the content is derived. As a solvent for measurement, chloroform-d (deuterated chloroform) solvent may be used.

<Other Resins>

The resin which is a component of the toner particles of the present invention is preferably made up of a polyester resin as described above. However, another resin may be included if the content thereof is less than 10 mass % relative to the whole resins. Such a resin other than the polyester resin may, for example, be styrene acrylic resin, urethane resin, epoxy resin, or the like.

If the content of such a resin other than the polyester resin is 10 mass % or more, the molecular chains of the polyester resin could be difficult to be regularly arranged, which may not be preferred depending on the case.

<Pigment>

The pigment included in the toner particles of the present invention is dispersed in the above-described resin. Such a pigment preferably has a particle size of 0.3 μm or less. If the particle size of the pigment is larger than 0.3 μm, dispersion of the pigment is deteriorated, which could reduce the glossiness and make it impossible to obtain a desired color.

Further, the amount of the pigment included in the toner particles may be set to 1 to 30 mass %, and preferably set to a range of 2 to 20 mass %, relative to the whole toner particles. If the amount of the pigment is less than 1 mass %, a sufficient coloring effect could fail to be obtained depending on the case. If the amount thereof is larger than 30 mass %, the pigment is difficult to be evenly dispersed, which could lower the glossiness due to agglomeration of the pigment. The proper amount of the pigment varies depending on the particle size, and the amount of the pigment tends to be larger as the particle size of the pigment is smaller.

As such a pigment, any conventionally known pigment may be used without being particularly limited. In terms of factors such as cost, light stability, and coloring property, the following pigments for example are preferably used. It is noted that these pigments are usually classified into black pigment, yellow pigment, magenta pigment, and cyan pigment, in terms of the constitution of colors. Basically, the colors (color image) except for black are created by subtractive color mixture of a yellow pigment, a magenta pigment, and a cyan pigment.

The black pigment (colorant for black) may, for example, be carbon black such as furnace black, channel black, acetylene black, thermal black, and lamp black, and magnetic powder such as magnetite and ferrite.

The magenta pigment (colorant for red) may, for example, be C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, or the like.

The yellow pigment (colorant for orange or yellow) may, for example, be C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 155, C.I. Pigment Yellow 180, C.I. Pigment Yellow 185, or the like.

The cyan pigment (colorant for green or cyan) may, for example, be C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, C.I. Pigment Blue 62, C.I. Pigment Blue 66, C.I. Pigment Green 7, or the like.

Regarding these pigments, a single pigment or two or more different pigments in combination may be used.

<Insulating Liquid>

The insulating liquid included in the liquid developer of the present invention is preferably nonvolatile at normal temperature, and is preferably electrically insulating (the resistance is for example in a range of 10¹¹ to 10¹⁶ Ω·cm). This is for the reason that the insulating liquid having a resistance in this range will not usually disturb an electrostatic latent image. Further, such an insulating liquid preferably has no odor and toxicity.

Such an insulating liquid may, for example, be aliphatic hydrocarbon, alicyclic hydrocarbon, aromatic hydrocarbon, halogenated hydrocarbon, polysiloxane, or the like. In particular, in terms of odor, harmlessness, and cost, normal paraffin-based solvent and isoparaffin-based solvent are preferred. More specifically, it may be MORESCO White P40 (trademark, flash point: 140° C.), MORESCO White P60 (trademark, flash point: 170° C.), and MORESCO White P120 (trademark, flash point: 200° C.) that are manufactured by MORESCO Corporation, Isopar (trademark, manufactured by ExxonMobil Chemical), Shellsol 71 (trademark, manufactured by Shell Chemicals), IP Solvent 1620 (trademark, manufactured by Idemitsu Chemicals), IP Solvent 2028 (trademark, flash point: 84° C., manufactured by Idemitsu Chemicals), or the like.

Regarding these insulating liquids, a single insulating liquid or two or more different insulating liquids in combination may be used.

<Dispersant>

The dispersant included in the liquid developer of the present invention has a function of providing stable dispersion of the toner particles in the insulating liquid, and includes a basic polymeric dispersant. Such a dispersant is usually present (adsorbed) on the surface of the toner particles, and is preferably soluble in the insulating liquid.

It is requisite for the dispersant of the present invention to include a basic polymeric dispersant. This is for the following reason. The resin included in the toner particles has a carboxylic acid at its end. Thus, the basic polymeric dispersant is used so that the interaction between the carboxylic acid and the basic polymeric dispersant enables a good dispersion property of the toner particles to be stabilized for a long period of time. Further, while such a dispersant is requisite for uniformly dispersing the toner particles as described above, the insulating liquid is taken into the toner particles through the dispersant. It is thus desired to use a small amount of the dispersant, since a greater amount of the dispersant causes a greater amount of the insulating liquid to remain together with the toner particles after the fixing process, which accordingly plasticizes the toner particles and causes the document offset.

Thus, according to the present invention, a basic polymeric dispersant is included as a dispersant, so that the above-described interaction between the resin of the toner particles and the dispersant can be obtained, and consequently a small amount of the added dispersant can provide a high dispersion property of the toner particles. Accordingly, the amount of the insulating liquid taken into the toner particles is reduced, which enables the document offset to be prevented highly effectively. Further, such a basic polymeric dispersant will be readily separated from the toner particles by the heat in the fixing process. In this respect as well, the basic polymeric dispersant is expected to help reduction of the amount of the insulating liquid that is taken into the toner particles.

An example of such a basic polymeric dispersant may be a nitrogen-containing resin having, in its molecules, an amine group, an amide group, an imine group, a pyrrolidone group, a urethane group, or the like. In particular, a basic polymeric dispersant having, in its molecules, any of a urethane group, an amide group, and a pyrrolidone group is appropriate. This is because such a basic polymeric dispersant can be used to reduce the amount of the dispersant to be used.

The basic polymeric dispersant having an urethane group may, for example, be a copolymer of a vinyl compound having a long-chain alkyl group and a compound that is obtained by reacting a compound having an alcohol group (OH group) at the end and a compound having an isocyanate group, or the like. Here, the compound having an alcohol group (OH group) at the end may, for example, be hydroxyethyl methacrylate, hydroxyethyl acrylate, or the like. The compound having an isocyanate group may, for example, be tolylene diisocyanate, isophorone diisocyanate, or the like.

Specific examples of the basic polymeric dispersant may include “Disperbyk-109 (alkylolamino amide)” (trademark) and “Disperbyk-130 (unsaturated polycarboxylic acid polyamino amide)” (trademark) that are manufactured by BYK Chemie, “Solsperse 13940 (polyester amine based)” (trademark), “Solsperse 17000” (trademark), “Solsperse 18000” (trademark), “Solsperse 19000 (aliphatic acid amine based)” (trademark), and “Solsperse 11200” (trademark) that are manufactured by Lubrizol Japan Limited, and the like. A more preferred example may be a copolymer of a compound expressed by formula (II) below and a compound expressed by formula (III) below (namely a copolymer of a vinyl compound having a long-chain alkyl group and polyvinyl pyrrolidone). Such a copolymer may be “Antaron V-216” (trademark), “Antaron V-220” (trademark), and “Antaron W-660” (trademark) manufactured by GAF/ISP Chemicals.

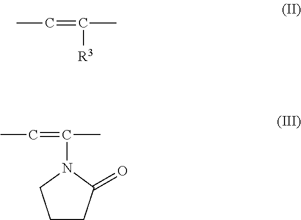

In formula (II) above, R³ represents an alkyl group with a carbon number of 10 to 30. The ratio of copolymerization (molar ratio) between the compound expressed by formula (II) and the compound expressed by formula (III) is not particularly limited. The ratio, however, is preferably in a range of 20:80 to 90:10, and more preferably in a range of 50:50 to 90:10. If the ratio of the compound of formula (III) is lower, the dispersion property of the toner particles is deteriorated. If the carbon number of R³ in Formula (II) is less than 10, the dispersion property of the toner particles is deteriorated. If the carbon number thereof is more than 30, the dispersant is difficult to be dissolved in the insulating liquid.

Regarding the dispersant (basic polymeric dispersant) of the present invention, a single dispersant or two or more different dispersants in combination may be used. Further, the dispersant of the present invention may be made up of the basic polymeric dispersant only, or a different dispersant such as basic low molecular weight dispersant or acid dispersant may be used in combination with the basic polymeric dispersant.

<Manufacturing Method>

The liquid developer of the present invention may be prepared based on a conventionally known technique such as granulation method or pulverization method. The granulation method may be suspension polymerization method, emulsion polymerization method, particle coagulation method, a method that adds a poor solvent to a resin solution and precipitates the resin, spray drying, or the like. In the case of the suspension polymerization and emulsion polymerization methods, a method may be used such as a method according to which water is used as a continuous phase and, after toner particles are prepared, the continuous phase is replaced with an insulating liquid, or a method according to which toner particles are prepared by polymerization directly in the insulating liquid.

Another method may also be used according to which a resin solution in which a pigment is dispersed in the resin solution is prepared, the resin solution is dispersed in an insulating liquid, and an appropriate dispersant is used to emulsify it and thereby obtain toner particles. In this case, as a solvent for the resin solution, a solvent which is incompatible with the insulating liquid is selected.

In the case of the pulverization method, a resin and a pigment are melted and kneaded in advance, and the resultant mixture is pulverized. Pulverization is suitably performed in a dry state or a wet state in an insulating liquid.

It is noted that after the toner particles are produced, the toner particles are preferably heated to 40 to 50° C., since the resin molecules in the toner particles are regularly arranged by this heating.

### EXAMPLES

In the following, the present invention will be described in more detail in connection with Examples. The present invention, however, is not limited to them. It is noted that the term “parts” in the Examples means “parts by mass” unless otherwise noted.

<Synthesis of Alkylene Oxide Adduct of Bisphenol A>

In an autoclave having stirring and temperature adjustment capabilities, 228 g of bisphenol A and 2 g of potassium hydroxide were placed, 139 g of propylene oxide was introduced at 135° C. under a pressure in a range of 0.1 to 0.4 MPa, and they were thereafter reacted with each other for three hours. To the reaction product, 16 g of an adsorbent “Kyowaad 600” (manufactured by Kyowa Chemical Industry Co., Ltd.) was added, and they were stirred at 90° C. for 30 minutes and aged. Filtering was thereafter performed to obtain a propylene oxide adduct of bisphenol A. The obtained propylene oxide adduct of bisphenol A was a mixture of a compound of formula (I) where m+n was 2 and a compound of formula (I) where m+n was 3.

Further, in an autoclave having stirring and temperature adjustment capabilities, 228 g of bisphenol A and 2 g of potassium hydroxide were placed, 96 g of ethylene oxide was introduced at 135° C. under a pressure in a range of 0.1 to 0.4 MPa, and they were thereafter reacted with each other for three hours. To the reaction product, 16 g of an adsorbent “Kyowaad 600” (manufactured by Kyowa Chemical Industry Co., Ltd.) was added, and they were stirred at 90° C. for 30 minutes and aged. Filtering was thereafter performed to obtain an ethylene oxide adduct of bisphenol A. The obtained ethylene oxide adduct of bisphenol A was a mixture of a compound of formula (I) where m+n was 2, a compound of formula (I) where m+n was 3, and a compound of formula (I) where m+n was 4.

<Synthesis of Polyester Resin>

As a resin included in the toner particles, a polyester resin was synthesized in the following way.

Specifically, in a four-necked flask provided with a stirring rod, a partial condenser, a nitrogen gas feed pipe, and a thermometer, 280 parts of the above-described propylene oxide adduct of bisphenol A which was an aromatic monomer to form alcohol component units, 120 parts of 1,6-hexanediol which was an aliphatic monomer to form alcohol component units, 280 parts of terephthalic acid which was an aromatic monomer to form acid component units, and 120 parts of adipic acid which was an aliphatic monomer to form acid component units were placed, nitrogen gas was introduced while they were stirred, and they were polycondensed at 170° C. for five hours.

Subsequently, the temperature was lowered to approximately 100° C., and 0.012 parts of hydroquinone was added as a polymerization inhibitor to stop the polycondensation and thereby obtain a polyester resin. The polyester resin obtained in this way was named “Polyester Resin A.”

Further, Polyester Resins B to H were obtained in a similar way to the above-described one except that the composition of the raw material monomers (aliphatic monomers and aromatic monomers) was those shown in Table 1. It is noted that, in Table 1, “bisphenol A-ethylene oxide adduct” (namely ethylene oxide adduct of bisphenol A) refers to the one synthesized in the above-described manner.

These Polyester Resins A to H were subjected to ¹H-NMR analysis using a Fourier transform nuclear magnetic resonance apparatus (FT-NMR) (trademark: “Lambda 400” manufactured by JEOL Ltd.). From the integration ratio obtained by the analysis, the ratio of the total amount of units derived from the aliphatic monomers included in the acid component units and the alcohol component units was determined. As a solvent for the measurement, chloroform-d (deuterated chloroform) solvent was used. The results are shown in Table 2 (under “aliphatic monomer (mol %)”). The results of the measurement shown in Table 2 conformed to the composition of the raw material monomers.

TABLE 1

| | alcohol component units | | acid component units | |
|---|---|---|---|---|
| | aromatic monomer | aliphatic monomer | aromatic monomer | aliphatic monomer |
| Polyester Resin A | bisphenol A-propylene | 1,6-hexanediol/ | terephthalic acid/ | adipic acid/ |
| | oxide adduct/ | 120 parts | 280 parts | 120 parts |
| | 280 parts | | | |
| Polyester Resin B | bisphenol A-propylene | 1,6-hexanediol/ | terephthalic acid/ | adipic acid/ |
| | oxide adduct/ | 320 parts | 80 parts | 320 parts |
| | 80 parts | | | |
| Polyester Resin C | bisphenol A-propylene | 1,6-hexanediol/ | terephthalic acid/ | adipic acid/ |
| | oxide adduct/ | 200 parts | 200 parts | 200 parts |
| | 200 parts | | | |
| Polyester Resin D | bisphenol A-ethylene oxide | 1,4-butanediol/ | isophthalic acid/ | sebacic acid/ |
| | adduct/ | 200 parts | 200 parts | 200 parts |
| | 200 parts | | | |
| Polyester Resin E | bisphenol A-propylene | 1,6-hexanediol/ | terephthalic acid/ | adipic acid/ |
| | oxide adduct/ | 340 parts | 60 parts | 340 parts |
| | 60 parts | | | |
| Polyester Resin F | bisphenol A-propylene | 1,6-hexanediol/ | terephthalic acid/ | adipic acid/ |
| | oxide adduct/ | 80 parts | 320 parts | 80 parts |
| | 320 parts | | | |
| Polyester Resin G | bisphenol A-propylene | 1,6-hexanediol/ | terephthalic acid/ | adipic acid/ |
| | oxide adduct/ | 20 parts | 380 parts | 20 parts |
| | 380 parts | | | |
| Polyester Resin H | bisphenol A-propylene | 1,6-hexanediol/ | terephthalic acid/ | adipic acid/ |
| | oxide adduct/ | 380 parts | 20 parts | 380 parts |
| | 20 parts | | | |

TABLE 2

| | aliphatic monomer |
|---|---|
| | (mol %) |
| Polyester Resin A | 30 |
| Polyester Resin B | 80 |
| Polyester Resin C | 50 |
| Polyester Resin D | 50 |
| Polyester Resin E | 85 |
| Polyester Resin F | 20 |
| Polyester Resin G | 5 |
| Polyester Resin H | 95 |

### Example 1

500 parts of glass beads (diameter: 1 mm) were added to 100 parts of Polyester Resin A, 25 parts of a copper-phthalocyanine-blue-based cyan pigment (trademark: “Fastogen Blue GNPT” manufactured by DIC Corporation) as a pigment, 400 parts of acetone, and 5 parts of a pigment dispersant (trademark: “Solsperse 28000” manufactured by Lubrizol Japan), and they were mixed by means of a paint conditioner for two hours so that the pigment was dispersed to thereby produce a resin solution in which the pigment was dispersed.

Then, 5 parts of a dispersant that was a copolymer of N-vinylpyrrolidone and a vinyl compound having a long-chain alkyl group, which was a basic polymeric dispersant having a pyrrolidone group in its molecules (trademark:“Antaron V-216” manufactured by GAF/ISP Chemicals) were dissolved in 70 parts of an insulating liquid (trademark: “IP Solvent 2028” manufactured by Idemitsu Chemicals), and a homogenizer was activated. Into the homogenizer being activated, 150 parts of the resin solution obtained in the above-described manner were introduced, and they were mixed for five minutes to produce a liquid developer precursor.

Then, an evaporator was used to remove the acetone from the liquid developer precursor to thereby obtain a liquid developer in which toner particles having a particle size of 2.5 μm were dispersed. This liquid developer was further stored in a constant-temperature bath of 50° C. for four hours to thereby obtain a liquid developer of the present invention.

### Examples 2-4 and Comparative Examples 1-2

Liquid developers were obtained in a similar manner to Example 1 except that polyester resins indicated in Table 3 were used instead of Polyester Resin A of Example 1. It is noted that “mol %” indicated under “Polyester Resin” in Table 3 represents the ratio of the total amount of units derived from an aliphatic monomer.

### Example 5

A liquid developer was obtained in a similar manner to Example 1 except that 64 parts of Polyester Resin G and 36 parts of Polyester Resin H were used instead of 100 parts of Polyester Resin A of Example 1. It is noted that “mol %” indicated under “Polyester Resin” in Table 3 represents the ratio of the total amount of units derived from an aliphatic monomer to the sum of 64 parts of Polyester Resin G and 36 parts of Polyester Resin H.

### Examples 6-7 and Comparative Examples 3-4

Liquid developers were obtained in a similar manner to Example 1 except that the polyester resins indicated in Table 3 were used instead of Polyester Resin A of Example 1 and dispersants detailed below were used instead of “Antaron V-216.”

Specifically, regarding Example 6, as a basic polymeric dispersant having an urethane group in its molecules, a compound was used that was produced by copolymerization of a monomer which was hydroxyethyl methacrylate (a compound having an alcohol group at its end) with its end OH group modified by isophorone diisocyanate (a compound having an isocyanate group) (namely the monomer was a compound obtained by reacting these compounds with each other) and hexadecane (vinyl compound having a long-chain alkyl group).

Regarding Example 7, an amine-based basic polymeric dispersant (trademark: “Solsperse 13940” manufactured by Lubrizol Japan) was used. Regarding Comparative Examples 3 and 4, an acid dispersant (trademark: “Solsperse 3000” manufactured by Lubrizol Japan) was used.

<Measurement of Melting Point of Dry Solid>

The melting points of solids obtained by drying the liquid developers of the Examples and Comparative Examples obtained in the above-described manner were measured in the following way.

Specifically, the liquid developers of the Examples and Comparative Examples were first applied to a support such as tile to a thickness of 2 to 3 μm and left as they were at normal temperature and normal pressure for 24 hours to thereby obtain solids into which the liquid developers on the support had been dried. 20 mg of each solid was weighed and used as a sample for measurement.

Then, this sample and 20 mg of alumina serving as a reference were set on a differential scanning calorimeter (trademark: “DSC-6200” manufactured by Seiko Instruments Inc.) and, in an atmosphere of nitrogen gas (30 to 50 ml/min) and under the condition that the temperature increase rate was 10° C./min, the temperature was increased from room temperature to 200° C. Subsequently, the temperature was decreased at 30° C./min to 0° C. After this, the temperature was increased again at a rate of 10° C./min to thereby measure a shoulder value of an endothermic shift.

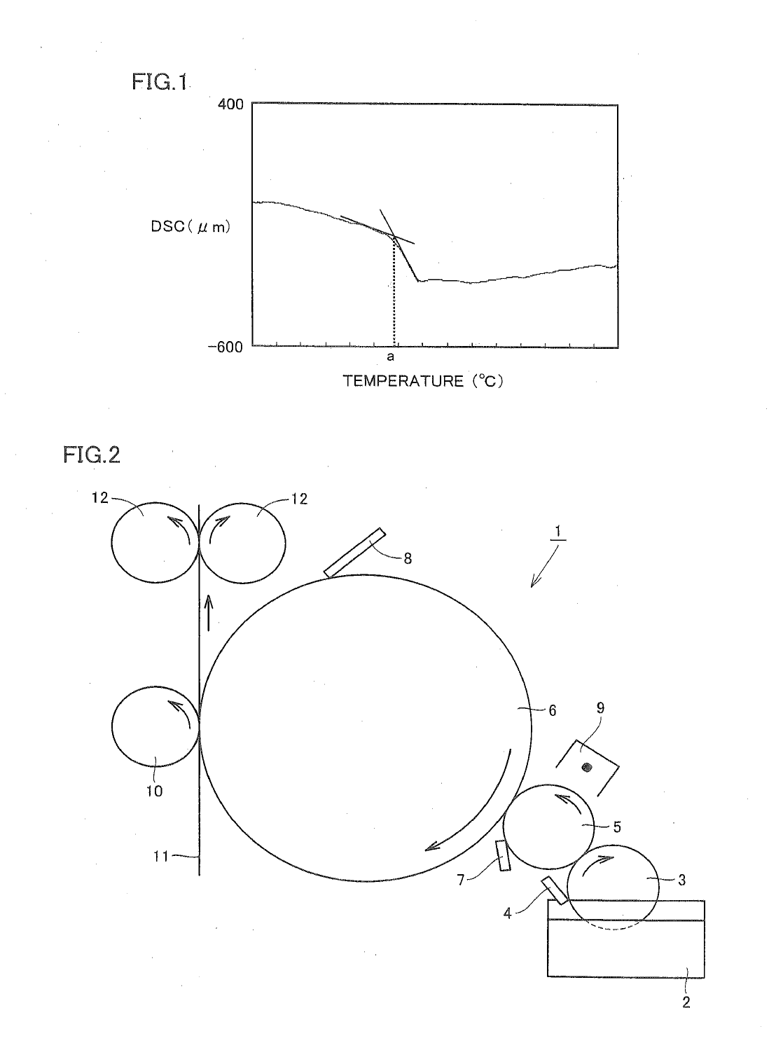

The shoulder value of the endothermic shift is as follows. In a range of 30 to 100° C. of the temperature increased for the second time, the shoulder value is, as shown in FIG. 1, the intersection of the extension of the base line (the line having a smaller gradient in FIG. 1) and the tangent of the endothermic shift (inflection point). The temperature of the intersection is a melting point. The results of measurement are shown in Table 3 (under “melting point of dry solid”). FIG. 1 is a graph showing an example of the results of measurement of the shoulder value of the endothermic shift, the vertical axis represents heat flow and the horizontal axis represents temperature.

<Evaluation of Dispersion Property>

10 cc of each of the liquid developers of the Examples and Comparative Examples obtained in the above-described manner was placed in a 20 cc glass bottle and set stationary in an environment at a set temperature of 25 to 30° C. for one week. After this, the state of each liquid developer was visually observed and evaluated by ranking it as one of the following three levels. The dispersion property is defined in a descending order from A to C. The results are shown in Table 3 (under “Dispersion Property”).

A: Re-dispersion is caused by shaking.

B: Re-dispersion is caused by stirring with a spatula or the like.

C: No re-dispersion occurs (toner is agglomerated and solidified).

<Evaluation of Granulation Property>

The volume-average particle size of toner particles in each of the liquid developers of the Examples and Comparative Examples obtained in the above-described manner was measured with a particle size distribution meter (trademark: “SALD-2200” manufactured by Shimadzu Corporation), and evaluated by ranking it as one of the following four levels. The granulation property is defined in a descending order from A to D. The results are shown in Table 3 (under “Granulation Property”).

A: The volume-average particle size is 5 μm or less.

B: The volume-average particle size is 10 μm or less.

C: The volume-average particle size is 20 μm or less.

D: The volume-average particle size is larger than 20 μm.

<Evaluation of Anti-Document-Offset Property>

An image forming apparatus in FIG. 2 was used to form a solid-pattern image of each of the liquid developers of the Examples and Comparative Examples obtained in the above-described manner (pattern image's area: 10 cm×10 cm, amount of applied developer of the pattern image: 2 mg/m²) on coated paper (trademark: “OK top coat+(127.9 g/m²)” manufactured by Oji Paper Co., Ltd.), and the solid-pattern image was fixed with a heat roller (temperature: 180° C., nip time: 80 msec) to thereby obtain a sample in the form of the solid-pattern image on the coated paper. Two samples were prepared for each of the Examples and Comparative Examples.

Then, the samples were set so that the pattern images of the samples overlap and abut on each other and a weight of 10 g/cm² was put on one of the surfaces where the solid-pattern images were not formed. The samples were left as they were for one week in a constant-temperature bath with a temperature set to 50° C.

After this, the samples were removed from the constant-temperature bath and cooled to room temperature. Then, the overlapping samples were separated from each other and evaluated by ranking the samples as one of the following three levels. The anti-document-offset property is defined in a descending order from A to C. The results are shown in Table 3 (under “Anti-Document-Offset Property”).

A: The solid-pattern does not peel off from the coated paper.

B: The solid-pattern or the coating layer of the coated paper peels off.

C: The coated paper tears.

It is noted that the process conditions and an outline of the process of the image forming apparatus used as described above are as follows.

<Process Conditions>

System speed: 40 cm/s

Photoconductor: negatively charged OPC

Charge potential: −700 V

Development voltage (voltage applied to development roller): −450 V

Transfer voltage (voltage applied to transfer roller): +600 V

Pre-development corona CHG: appropriately adjusted in a range of 3 to 5 kV of voltage applied to needle

<Outline of Process>

FIG. 2 is a schematic conceptual diagram of an electrophotographic image forming apparatus 1. A liquid developer 2 is first raised by a feed roller 3 and partially scraped by a restriction blade 4 so that a thin layer of the liquid developer with a predetermined thickness is formed on feed roller 3 (in the case of an anilox roller, pits made in the roller are filled with the liquid developer, and a specified amount of the developer is measured by the restriction roller).

Subsequently, the thin layer of the liquid developer is moved from feed roller 3 onto a development roller 5 and, by nipping between development roller 5 and a photoconductor 6, toner particles are moved onto photoconductor 6 and accordingly a toner image is formed on photoconductor 6. After this, by nipping between photoconductor 6 and a backup roller 10, the toner image is transferred onto a recording material 11, and the image is fixed by a heat roller 12. It is noted that image forming apparatus 1 also includes a cleaning blade 7, cleaning blade 8, and a charging device 9 in addition to the above-described components.

TABLE 3

| | | Melting Point of | Dispersion | Granulation | Anti-Document-Offset |
|---|---|---|---|---|---|
| | Polyester Resin | Dry Solid (° C.) | Property | Property | Property |
| Example 1 | A (30 mol %) | 56 | A | A | B |
| Example 2 | B (80 mol %) | 69 | A | B | A |
| Example 3 | C (50 mol %) | 65 | A | A | A |
| Example 4 | D (50 mol %) | 65 | A | A | A |
| Example 5 | G/H (50 mol %) | 66 | A | A | A |
| Example 6 | C (50 mol %) | 65 | A | A | A |
| Example 7 | C (50 mol %) | 55 | B | A | B |
| Comparative | F (20 mol %) | 48 | A | A | C |
| Example 1 | | | | | |
| Comparative | E (85 mol %) | 75 | A | D | A |
| Example 2 | | | | | |
| Comparative | C (50 mol %) | 50 | C | C | C |
| Example 3 | | | | | |
| Comparative | F (20 mol %) | 48 | C | C | C |
| Example 4 | | | | | |

As clearly seen from Table 3, the liquid developers of the Examples have been confirmed as exhibiting a superior anti-document-offset property and also exhibiting a superior dispersion property and a superior granulation property, relative to the liquid developers of the Comparative Examples. In contrast, the liquid developers of the Comparative Examples have been confirmed as having an inferior anti-document-offset property or failing to exhibit both the anti-document-offset property and other characteristics such as granulation property even if it has a good anti-document-offset property.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A liquid developer comprising toner particles, an insulating liquid, and a dispersant,
said toner particles including a resin and a pigment dispersed in the resin,
said resin including a polyester resin,
said dispersant including a basic polymeric dispersant, and
a melting point of a solid obtained by drying said liquid developer being at least 55° C.

2. The liquid developer according to claim 1, wherein said basic polymeric dispersant includes, in its molecules, any one of a urethane group, an amide group, and a pyrrolidone group.

3. A liquid developer comprising toner particles, an insulating liquid, and a dispersant,
said toner particles including a resin and a pigment dispersed in the resin,
said resin including a polyester resin,
said dispersant including a basic polymeric dispersant,
a melting point of a solid obtained by drying said liquid developer being at least 55° C., and
said polyester resin including units derived from an acid component and units derived from an alcohol component, and a total amount of units derived from an aliphatic monomer included in the units derived from an acid component and the units derived from an alcohol component being 30 to 80 mol %.

4. The liquid developer according to claim 3, wherein said basic polymeric dispersant includes, in its molecules, any one of a urethane group, an amide group, and a pyrrolidone group.
